(19) United States
(12) Patent Application Publication
(10) Pub. No.: US 2023/0391646 A1
(43) Pub. Date: Dec. 7, 2023

(54) Decorative Chlorine Dispenser

(71) Applicant: Jeffery Cymbalski, Cave Creek, AZ (US)

(72) Inventor: Jeffery Cymbalski, Cave Creek, AZ (US)

(21) Appl. No.: 18/329,137

(22) Filed: Jun. 5, 2023

Related U.S. Application Data
(60) Provisional application No. 63/349,323, filed on Jun. 6, 2022.

(51) Int. Cl. C02F 1/68

(52) U.S. Cl. CPC C02F 1/688; C02F 2103/42

(57) ABSTRACT

A decorative chlorine dispenser is disclosed. The decorative chlorine dispenser includes an upper member with a decorative interface in which the upper member is swapped out as needed to change a decorative aesthetic of the decorative chlorine dispenser. The decorative chlorine dispenser includes a lower member with a cavity to store and dispense a plurality of chlorine tablets. The decorative element is a basketball ball figurine, a football ball figurine, a baseball ball figurine, a soccer ball figurine, a golf ball figurine, or the like. The decorative chlorine dispenser includes a thermometer to detect temperature of water in the pool.

### CROSS REFERENCE TO RELATED APPLICATIONS

This application claims the benefit of U.S. Provisional Application No. 63/349,323 filed on Jun. 6, 2022. The above identified patent application is herein incorporated by reference in its entirety to provide continuity of disclosure.

### BACKGROUND OF THE INVENTION

The present invention relates to a dispenser. More specifically, the present invention relates to a decorative chlorine dispenser.

Many people own or manage pools for professional, competitive, or recreational purposes. Pools, spas, and other similar apparatuses, require their owners to maintain the chlorine balance of their water. Maintaining the chlorine balance ensures that the apparatuses remain clean and sanitary. In addition to maintaining the chlorine balance, users may wish to know the water temperature when they are maintaining their pools.

Traditionally, a wide assortment of devices has been utilized to assist users in maintaining chlorine balance. For example, floating devices designed to accommodate the release of chlorine have been made and marketed to efficiently assist users in maintaining chlorine balance. These devices typically include a housing to release chlorine tablets gradually and are low profile devices designed to float at the top of the water. These devices rarely provide aesthetic value to a pool, and generally when they do, they do not enable the user to customize or alter the decorative elements.

Therefore, there is a defined need amongst the known prior art references for a device that enables users to provide a customized decorative aspect that is removable, such as to enable the addition of a different decorative aspect.

### SUMMARY OF THE INVENTION

In view of the foregoing disadvantages inherent in the known types of decorative chlorine dispensers now present in the prior art, the present invention provides a decorative chlorine dispenser wherein the same may be utilized for providing convenience for the user when using a decorative chlorine dispenser.

The present system comprises a decorative chlorine dispenser that includes an upper member with a decorative interface in which the upper member is swapped out as needed to change a decorative aesthetic of the decorative chlorine dispenser. The decorative chlorine dispenser includes an upper member with an upper member housing with a decorative element disposed on a top surface of an upper member housing. The decorative chlorine dispenser includes a lower member having a cavity to store and dispense a plurality of chlorine tablets, the lower member is with a cylindrical chamber with a plurality of parallel slots, and the cylindrical chamber extends downward from the lower member. The decorative element is a basketball ball figurine, a football ball figurine, a baseball ball figurine, a soccer ball figurine, a golf ball figurine, or the like.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of a basketball ball figurine embodiment of the decorative chlorine dispenser.

FIG. 2 shows a perspective view of an American football ball figurine embodiment of the decorative chlorine dispenser.

FIG. 3 shows a perspective view of a baseball ball figurine embodiment of the decorative chlorine dispenser.

FIG. 4 shows a perspective view of a soccer ball figurine embodiment of the decorative chlorine dispenser.

FIG. 5 shows a perspective view of a golf ball figurine embodiment of the decorative chlorine dispenser.

### DETAILED DESCRIPTION OF THE INVENTION

Reference is made herein to the attached drawings. Like reference numerals are used throughout the drawings to depict like or similar elements of the decorative chlorine dispenser. The figures are intended for representative purposes only and should not be considered to be limiting in any respect.

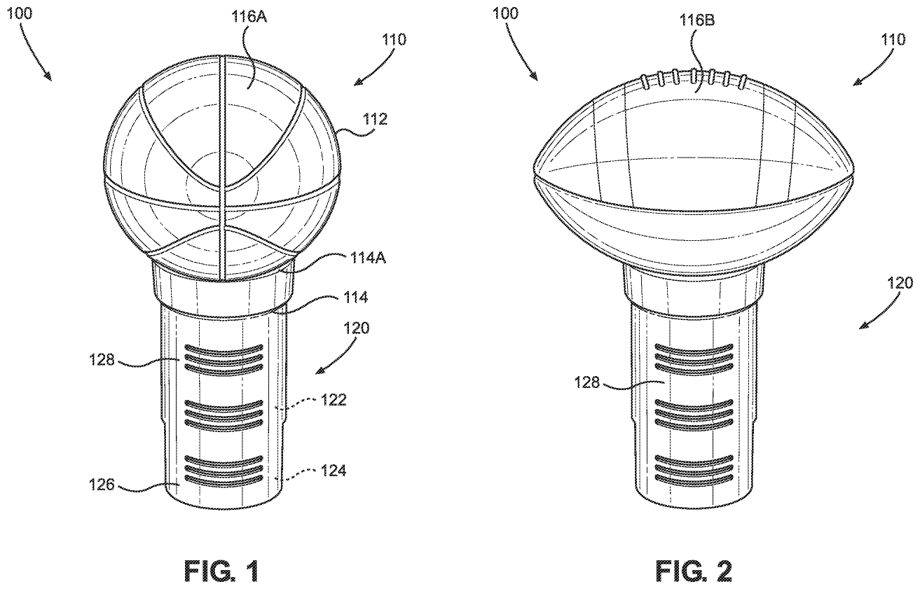

Referring now to FIGS. 1-4 there are several perspective views shown of embodiments of the decorative chlorine dispenser 100.

The decorative chlorine dispenser 100 may include an upper member 110 and a lower member 120.

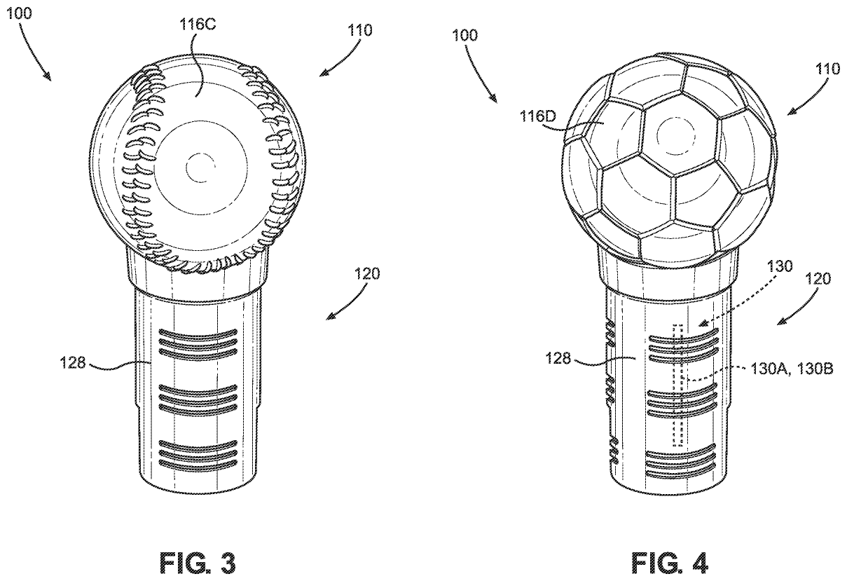

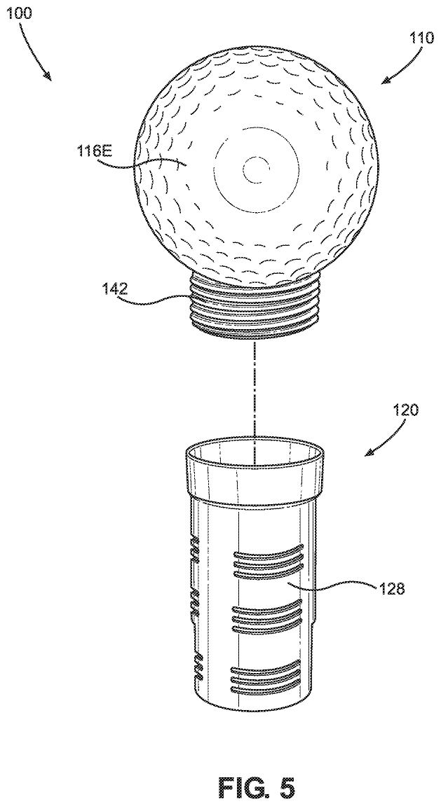

The upper member 110 may comprise a decorative interface 112 in which the upper member 110 may be swapped out as needed to change the decorative aesthetic of the decorative chlorine dispenser 100. In the illustrated embodiment, the upper member 110 may comprise an upper member housing 114 with a decorative element 116 disposed on a top surface 114A of the upper member housing 114. The decorative element 116 may be any decorative element capable of being displayed upon the upper member housing 114. For example, the decorative element 116 may be a basketball ball figurine 116A (as shown in FIG. 1), a football ball figurine 116B (as shown in FIG. 2), a baseball ball figurine 116C (as shown in FIG. 3), a soccer ball figurine 116D (as shown in FIG. 4), or a golf ball figurine 116E (as shown in FIG. 5) or the like.

The lower member 120 may comprise a cavity 122 configured to store and dispense chlorine tablets 124. In the illustrated embodiments, the lower member 120 may comprise a cylindrical chamber 126 with a plurality of parallel slots 128. The cylindrical chamber 126 may extend downward from the lower member 120, such that the cylindrical chamber 126 may be disposed underwater when in a pool. The cylindrical chamber 126 may be hollow, such that one of the chlorine tablets 124 may be gradually released through the cylindrical chamber 126.

In some embodiments, the decorative chlorine dispenser 100 may include a thermometer 130 to detect the temperature of the water in the pool. The thermometer 130 may be disposed on any suitable surface for the purpose of recording the temperature of the water. The thermometer 130 may be a mercury thermometer 130A, a digital thermometer 130B, or any other suitable form of thermometer.

Referring now to FIG. 5 there is shown a perspective view of an embodiment of the decorative chlorine dispenser 100. In the illustrated embodiment, the upper member 110 and the lower member 120 comprise a fastener 140 formed therebetween. The fastener 140 may secure the lower member 120 to the upper member 110. In the illustrated embodiment, the fastener 140 may be a threaded fastener 142 or the like.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A decorative chlorine dispenser, comprising:
an upper member comprising a decorative interface in which the upper member is swapped out as needed to change a decorative aesthetic of the decorative chlorine dispenser, the upper member comprises an upper member housing with a decorative element disposed on a top surface of an upper member housing; and
a lower member comprising a cavity to store and dispense a plurality of chlorine tablets, the lower member comprises a cylindrical chamber with a plurality of parallel slots, and the cylindrical chamber extends downward from the lower member.

2. The decorative chlorine dispenser, according to claim 1, wherein the decorative element is a basketball ball figurine.

3. The decorative chlorine dispenser, according to claim 1, wherein the decorative element is a football ball figurine.

4. The decorative chlorine dispenser, according to claim 1, wherein the decorative element is a baseball ball figurine.

5. The decorative chlorine dispenser, according to claim 1, wherein the decorative element is a soccer ball figurine.

6. The decorative chlorine dispenser, according to claim 1, wherein the decorative element is a golf ball figurine.

7. The decorative chlorine dispenser, according to claim 1, wherein the cylindrical chamber extends downward from the lower member such that the cylindrical chamber is disposed underwater when in a pool.

8. The decorative chlorine dispenser, according to claim 1, wherein the cylindrical chamber is hollow.

9. The decorative chlorine dispenser, according to claim 8, wherein one of the chlorine tablets are gradually released through the cylindrical chamber.

10. The decorative chlorine dispenser, according to claim 1, wherein the upper member and the lower member comprise a fastener formed therebetween.

11. The decorative chlorine dispenser, according to claim 10, wherein the fastener secures the lower member to the upper member.

12. The decorative chlorine dispenser, according to claim 10, wherein the fastener is a threaded fastener.

13. The decorative chlorine dispenser, according to claim 1, wherein the decorative chlorine dispenser includes a thermometer to detect temperature of water in the pool.

14. The decorative chlorine dispenser, according to claim 13, wherein the thermometer is a mercury thermometer.

15. The decorative chlorine dispenser, according to claim 13, wherein the thermometer is a digital thermometer.
